(19) United States
(12) Patent Application Publication
(10) Pub. No.: US 2022/0094432 A1
(43) Pub. Date: Mar. 24, 2022

(54) OPTICAL GATEWAY AND REMOTE MONITORING SYSTEM

(71) Applicant: Shenzhen Fugui Precision Ind. Co., Ltd., Shenzhen (CN)

(72) Inventors: JIAN-LI XU, Shenzhen (CN); CHEN-YANG MA, Shenzhen (CN); PENG XU, Shenzhen (CN); LIN TAN, Shenzhen (CN)

(21) Appl. No.: 17/143,525

(22) Filed: Jan. 7, 2021

(30) Foreign Application Priority Data
Sep. 21, 2020 (CN) 202010998181.7

(51) Int. Cl. H04B 10/073; G06K 19/06; H04W 48/16

(52) U.S. Cl. CPC H04B 10/0731; H04W 84/12; H04W 48/16; G06K 19/06046

(57) ABSTRACT

An optical gateway includes a light sensor unit, comprising at least one light sensor, configured to sense state information of a signal lamp of an external test device; a control unit, connected to the light sensor unit, and configured to obtain the state information of the signal lamp; and a communication unit, connected to the control unit and configured to send the status information of the signal lamp to an external cloud server. The invention also provides a remote monitoring system, and the user can obtain the state information of the external test device from the cloud server, and monitor the working state of the external test device in real time through the optical gateway and the remote monitoring system.

### CROSS-REFERENCE TO RELATED APPLICATIONS

This application claims priority to Chinese Patent Application No. 202010998181.7 filed on Sep. 21, 2020, the contents of which are incorporated by reference herein.

### FIELD

The subject matter herein generally relates to the field of gateways and particularly to an optical gateway and a remote monitoring system.

### BACKGROUND

Usually, a reminder light is installed on a test device to remind the current working status of the device. However, most test devices currently available do not have networking functions, so that the remote device cannot obtain the real-time status information of the device in time, which makes it impossible to realize remote monitoring. This problem can be solved by modifying the device, but the cycle of modifying the device may be long, the cost may be high, and the process may be complicated.

### BRIEF DESCRIPTION OF THE DRAWINGS

Implementations of the present disclosure will now be described, by way of example only, with reference to the attached figures.

FIG. 1 is a schematic diagram of modules of an embodiment of an optical gateway of the present invention.

FIG. 2 is a schematic diagram of modules of another embodiment of the optical gateway of the present invention.

FIG. 3 is a schematic diagram of modules of an embodiment of a remote monitoring system of the present invention.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The disclosure is described in relation to an optical gateway and a remote monitoring system.

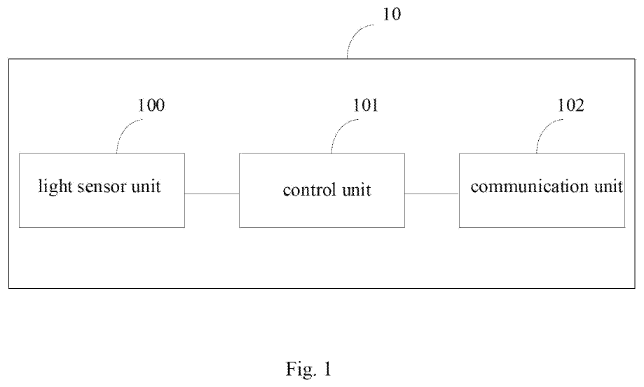

FIG. 1 is a schematic diagram of modules of an embodiment of an optical gateway of the present invention. In at least one exemplary embodiment, an optical gateway 10 comprises a light sensor unit 100, a control unit 101 and a communication unit 102.

In at least one embodiment, the light sensor unit 100 comprises at least one light sensor, and is configured to sense state information of a signal lamp of an external test device. Wherein, the at least one light sensor corresponds to the signal light of the external test equipment one-to-one. The control unit 101 is connected to the light sensor unit 100, and configured to obtain the state information of the signal lamp. The communication unit 102 is connected to the control unit 101 and configured to send the status information of the signal lamp to an external cloud server. The user can obtain the status signal from the external cloud server, and then know the working status of the external test equipment in real time.

In at least one embodiment, the signal lamp of the external test device includes at least one light-emitting diode, each light-emitting diode corresponds to a light sensor, each light-emitting diode has a different color, and the light-emitting diodes of different colors are lit to represent the current work of status of the external test device. For example, when the red light-emitting diode is lit, it means that the external test device is malfunctioning, the green light-emitting diode is lit to indicate that the external test device is working normally, and the yellow light-emitting diode is lit to indicate that the external test device is in alert state, such as the temperature exceeds a preset value. For example, if the signal lamp of the external device is a three-color lamp, correspondingly, the light sensor unit 100 comprises three light sensors, respectively corresponding to the three light-emitting diodes in the three-color lamp. When the light sensor unit 100 senses that the green light-emitting diode in the three-color lamp is lit, the control unit 101 obtains the state information of the three-color lamp (the green light-emitting diode is lit), and then the communication unit 102 will send the status information of the three-color lamp to the external cloud server. The user can obtain the status signal from the cloud server, and then know the working status of the external test device in real time. For example, when the status information of the obtained three-color light is that the green LED is lit, the user can know that the current external test device is normal run.

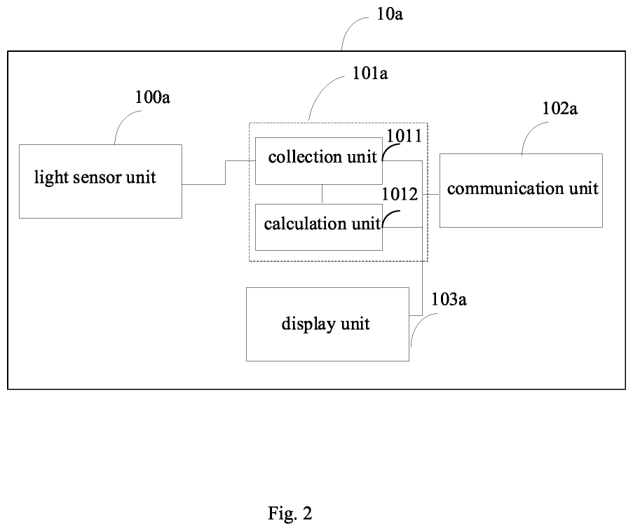

Referring to FIG. 2, FIG. 2 is a schematic diagram of modules of another embodiment of an optical gateway 10a of the present invention. The optical gateway 10a in FIG. 2 is an improvement based on the optical gateway 10 in FIG. 1. In at least one embodiment, the optical gateway 10a comprises a light sensor unit 100a, a control unit 101a, a communication unit 102a, and a display unit 103a.

In at least one embodiment, In at least one embodiment, the light sensor unit 100a comprises at least one light sensor, and is configured to sense state information of a signal lamp of an external test device. Wherein, the at least one light sensor corresponds to the signal light of the external test equipment one-to-one. The control unit 101a is connected to the light sensor unit 100a, and configured to obtain the state information of the signal lamp. The communication unit 102a is connected to the control unit 101 and configured to send the status information of the signal lamp to an external cloud server. The user can obtain the status signal from the external cloud server, and then know the working status of the external test equipment in real time. The display unit 103a is connected to the control unit 101a and configured to display the state information of the signal lamp and the running time of the external test device.

In at least one embodiment, the control unit 101a comprises a collection unit 1011 and a calculation unit 1012. The collection unit 1011 is connected to the light sensor unit 100a and the communication unit 102a and configured to obtain the state information of the signal lamp and collect the state data of the external test device. The state data of the external test device can be, but not limited to startup time, shutdown time, failure time, etc. The calculation unit 1012 is connected to the collection unit 1011 and configured to calculate running time of the external test device according to the state data of the external test device. The display unit 103a is further configured to display the running time of the external test device.

In at least one embodiment, the communication unit is a Wi-Fi unit, and the display unit 103a is configured to display Wi-Fi connection status and signal strength value.

In at least one embodiment, the display unit 103a is further configured to display device information and device QR code. Wherein the device information includes but is not limited to device model, IP address, serial number, etc.

In at least one embodiment, the display unit 103a may comprise a switching unit 1031 for switching the device information display interface and the QR code interface of the display unit 103a. The display unit 103a may be a touch display screen, and the switching unit 1031 may be a touch area provided under the touch display screen. When the display unit 103a switches to display the QR code, the user can scan the QR code interface code through the terminal device to bind with the external test device.

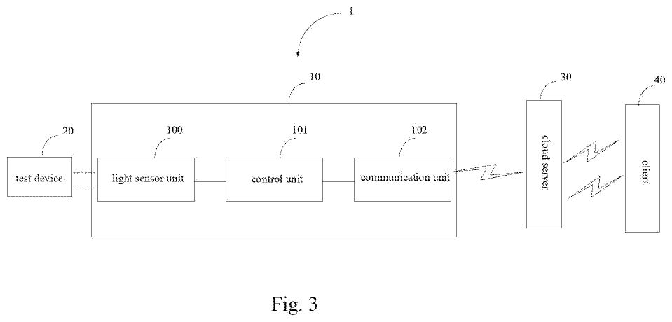

Referring to FIG. 3, FIG. 3 is a schematic diagram of modules of an embodiment of a remote monitoring system of the present invention. In at least one embodiment, the remote monitoring system 1 comprises a test device 20, the optical gateway 10, a cloud server 30, and a client 40.

In at least one embodiment, the test device 20 corresponds to the optical gateway 10 and includes a signal lamp, and different colors of the signal lamp represent different working states of the test device 20. The optical gateway 10 is configured to sense the state of the signal lamp and wirelessly send the state information. The cloud server 30 is configured to receive and store the state information. The client 40 is configured to obtain the status information from the cloud server 30 to monitor the working status of the test device 20.

In at least one embodiment, the optical gateway 10 includes a light sensor unit 100, a control unit 101, and a communication unit 102. The internal structure and working principle of the optical gateway 10 have been described in detail above, and will not be described in detail here.

In at least one embodiment, the signal lamp of the test device 200 includes at least one light-emitting diode, each light-emitting diode corresponds to a light sensor, each light-emitting diode has a different color, and the light-emitting diodes of different colors are lit to represent the current work of status of the test device 20. For example, when the red light-emitting diode is lit, it means that the external test device is malfunctioning, the green light-emitting diode is lit to indicate that the test device 200 is working normally, and the yellow light-emitting diode is lit to indicate that the test device 20 is in alert state, such as the temperature exceeds a preset value. For example, if the signal lamp of the external device is a three-color lamp, correspondingly, the light sensor unit 100 comprises three light sensors, respectively corresponding to the three light-emitting diodes in the three-color lamp. When the light sensor unit 100 senses that the green light-emitting diode in the three-color lamp is lit, the control unit 101 obtains the state information of the three-color lamp (the green light-emitting diode is lit), and then the communication unit 102 will send the status information of the three-color lamp to the external cloud server. The user can obtain the status signal from the cloud server 30 by the client 40, and then know the working status of the test device 20 in real time. For example, when the status information of the obtained three-color light is that the green LED is lit, the user can know that the current external test device is normal run.

In other embodiments of the present invention, the optical gateway 10 may further include a display unit. The display unit may also include a switching unit. The control unit 101 may also include a collection unit and a calculation unit. The working principles of the display unit, the switching unit, the collection unit, and the calculation unit have been described in detail above and will not be detailed here.

Compared with the prior art, the optical gateway and the remote monitoring system provided by the embodiments of the present invention sense the state information of the signal lamp through the light sensor unit, and send the state information to the cloud server, then The user monitors the working status of the equipment in real time by obtaining the status information of the external test equipment from the cloud server.

Many details are often found in the art such as the other features of the standby power supply device and the standby power supply system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. An optical gateway comprising:
a light sensor unit, comprising at least one light sensor, sensing state information of a signal lamp of an external test device;
a control unit, connected to the light sensor unit, and obtaining the state information of the signal lamp;
a communication unit, connected to the control unit and sending the state information of the signal lamp to an external cloud server;
a display unit, connected to the control unit and displaying the state information of the signal lamp and the running time of the external test device.

2. The optical gateway of claim 1, wherein the control unit comprises:
a collection unit, connected to the light sensor unit and the communication unit and obtaining the state information of the signal lamp and collecting the state data of the external test device;
a calculation unit, connected to the collection unit and calculating running time of the external test device according to the state data of the external test device.

3. (canceled)

4. The optical gateway of claim 1, wherein the communication unit is a Wi-Fi unit, and the display unit displays Wi-Fi connection status and signal strength value.

5. The optical gateway of claim 4, wherein the display unit displays information and an QR code of the device; and
the display unit comprises a switching unit for switching the device information display interface and QR code interface of the display unit.

6. A remote monitoring system, comprising:
a test device comprising a signal lamp;
an optical gateway, sensing state information of the signal lamp and sending the state information wirelessly, wherein the optical gateway a light sensor unit comprises:
at least one light sensor, sensing the state information of the signal lamp of an external test device;
a control unit, connected to the light sensor unit, and obtaining the state information of the signal lamp;
a communication unit, connected to the control unit and sending the state information of the signal lamp to an external cloud server;
a display unit, connected to the control unit and displaying the state information of the signal lamp and the running time of the external test device;
a cloud server, receiving and store the state information;
a client terminal, obtaining the state information from the cloud server to monitor working status of the test device.

7. The remote monitoring system of claim 6, wherein the optical gateway comprises:
a collection unit, connected to the light sensor unit and the communication unit and obtaining the state information of the signal lamp and collecting the state data of the external test device;
a calculation unit, connected to the collection unit and calculating running time of the external test device according to the state data of the external test device.

8. (canceled)

9. The remote monitoring system of claim 6, wherein the communication unit is a Wi-Fi unit, and the display unit displays Wi-Fi connection status and signal strength value.

10. The remote monitoring system of claim 6, wherein the display unit displays information and an QR code of the device; and
the display unit comprises a switching unit for switching the device information display interface and QR code interface of the display unit.
